(19) United States
(12) Patent Application Publication
(10) Pub. No.: US 2025/0328551 A1
(43) Pub. Date: Oct. 23, 2025

(54) TRANSIT TIME OR DISTANCE BOUNDARY

(71) Applicant: Regina K. Ricchiuto, River Vale, NJ (US)

(72) Inventor: Regina K. Ricchiuto, River Vale, NJ (US)

(21) Appl. No.: 19/187,488

(22) Filed: Apr. 23, 2025

Related U.S. Application Data
(60) Provisional application No. 63/637,723, filed on Apr. 23, 2024.

(51) Int. Cl. G06F 16/29; G06Q 50/16

(52) U.S. Cl. CPC G06F 16/29; G06Q 50/16

(57) ABSTRACT

In accordance with one aspect, a system includes at least one processor and one or more memory storing instructions. The instructions, when executed by the at least one processor, cause the system at least to perform: displaying a geographical map region containing a physical address entered by a user; determining at least one geographical boundary including at least one of: a transit-time boundary or a transit-distance boundary with respect to the physical address; and displaying the at least one geographical boundary on the geographical map region.

### CROSS-REFERENCE TO RELATED APPLICATIONS

The present application claims priority to U.S. Provisional Application No. 63/637,723, filed Apr. 23, 2024, which is hereby incorporated by reference herein in its entirety.

### TECHNICAL FIELD

The present disclosure relates to transit time or transit distance, and more particularly, to analyses relating to a transit-time boundary or a transit-distance boundary.

### BACKGROUND

Real estate listing sites are online platforms designed to connect property buyers, sellers, and renters by providing a centralized space to browse and advertise available real estate. Users can filter listings based on location, price, property type, size, and other criteria to find options that suit their needs. Listings usually include information such as photos, floor plans, amenities, and square footage. These sites have revolutionized the real estate market by making it more accessible, transparent, and efficient for both professionals and everyday users. Such sites can be improved, and there is interest in improving real estate listing sites.

### SUMMARY

The present disclosure relates to analyses relating to a transit-time boundary or a transit-distance boundary.

In accordance with aspects of the present disclosure, a system includes: at least one processor, and one or more memory storing instructions. The instructions, when executed by the at least one processor, cause the system at least to perform: displaying a geographical map region containing a physical address entered by a user; determining at least one geographical boundary including at least one of: a transit-time boundary or a transit-distance boundary with respect to the physical address; and displaying the at least one geographical boundary on the geographical map region.

In accordance with aspects of the present disclosure, a processor-implemented method includes: displaying a geographical map region containing a physical address entered by a user; determining at least one geographical boundary including at least one of: a transit-time boundary or a transit-distance boundary with respect to the physical address; and displaying the at least one geographical boundary on the geographical map region.

In accordance with aspects of the present disclosure, a processor-readable medium stores instructions which, when executed by at least one process or a system, cause the system at least to perform: displaying a geographical map region containing a physical address entered by a user; determining at least one geographical boundary including at least one of: a transit-time boundary or a transit-distance boundary with respect to the physical address; and displaying the at least one geographical boundary on the geographical map region.

In aspects of the system, processor-implemented method, or processor-readable medium, the determining the at least one geographical boundary includes determining the transit-time boundary with respect to the physical address.

In aspects of the system, processor-implemented method, or processor-readable medium, the determining the transit-time boundary with respect to the physical address includes: determining travel times between the physical address and each location in a grid surrounding the physical address; and determining the transit-time boundary based on the determined travel times in the grid which satisfy a target travel time, where the target travel time is configurable by a user.

In aspects of the system, processor-implemented method, or processor-readable medium, the determining the at least one geographical boundary includes determining the transit-distance boundary with respect to the physical address.

In aspects of the system, processor-implemented method, or processor-readable medium, the determining the transit-distance boundary with respect to the physical address includes: determining travel distances between the physical address and each location in a grid surrounding the physical address; and determining the transit-distance boundary based on the determined travel distances in the grid which satisfy a target travel distance, where the target travel distance is configurable by a user.

In aspects of the system, processor-implemented method, or processor-readable medium, the determining the at least one geographical boundary includes determining at least one geographical boundary for at least one of: different time periods of a day, or different time period of a week.

The details of one or more embodiments of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

A detailed description of embodiments of the disclosure will be made with reference to the accompanying drawings, wherein like numerals designate corresponding parts in the figures:

FIG. 1 is an example of a graphical user interface (GUI) for entering a physical address, in accordance with aspects of the present disclosure;

FIG. 2 is an example of the GUI of FIG. 1 showing an address suggestion feature, in accordance with aspects of the present disclosure;

FIG. 3 is an example of another GUI showing various elements including a map showing a physical location entered by a user, in accordance with aspects of the present disclosure;

FIG. 4 is an example of a pop-up describing a zip code mode and a travel radius mode (“RETONE” mode);

FIG. 5 is an example of selectable fields for showing social information for a zip code in the GUI of FIG. 3, in accordance with aspects of the present disclosure;

FIG. 6 is an example of data showing transportation for work modes utilized in the zip code in the GUI of FIG. 3, in accordance with aspects of the present disclosure;

FIG. 7 is an example of data showing median household income in the zip code in the GUI of FIG. 3, in accordance with aspects of the present disclosure;

FIG. 8 is an example of data showing age distribution in the zip code in the GUI of FIG. 3;

FIG. 9 is an example of a GUI for showing data in regions that are within one or more transit time or distance boundary of a physical address (called RETONE community), in accordance with aspects of the present disclosure;

FIG. 10 is an example of selectable fields for showing social information for the RETONE community in the GUI of FIG. 9, in accordance with aspects of the present disclosure;

FIG. 11 is an example of data showing household income in the RETONE community in the GUI of FIG. 9, in accordance with aspects of the present disclosure;

FIG. 12 is an example of data showing age distribution in the RETONE community in the GUI of FIG. 9, in accordance with aspects of the present disclosure;

FIG. 13 is an example of using the search bar to search for businesses or points of interest in the RETONE community in the GUI of FIG. 9, in accordance with aspects of the present disclosure;

FIG. 14 is an example of map markers showing locations of cafes in the RETONE community in the GUI of FIG. 9, in accordance with aspects of the present disclosure;

FIG. 15 is an example of store information for a map marker selected by a user in the GUI of FIG. 9, in accordance with aspects of the present disclosure;

FIG. 16 is an example of information listings for the map markers in the GUI of FIG. 9, in accordance with aspects of the present disclosure;

FIG. 17 is an example of map markers for banks in the RETONE community in the GUI of FIG. 9, in accordance with aspects of the present disclosure;

FIG. 18 is an example of information listings for the map markers displayed in the GUI of FIG. 17, in accordance with aspects of the present disclosure;

FIG. 19 is an example of map markers for parks in the RETONE community in the GUI of FIG. 9, in accordance with aspects of the present disclosure;

FIG. 20 is an example of information listings for the map markers displayed in the GUI of FIG. 19, in accordance with aspects of the present disclosure;

FIG. 21 is an example of a display screen for accessing various commercial review selections, in accordance with aspects of the present disclosure;

FIG. 22 is an example of a display screen for accessing various residential review selections, in accordance with aspects of the present disclosure;

FIG. 23 is an example of an operation for determining and display at least one transit-time or transit-distance boundary, in accordance with aspects of the present disclosure; and

FIG. 24 is an example of components of a system, in accordance with aspects of the present disclosure.

### DETAILED DESCRIPTION

The present disclosure relates to transit time or transit distance, and more particularly, to analyses relating to a transit-time boundary or a transit-distance boundary

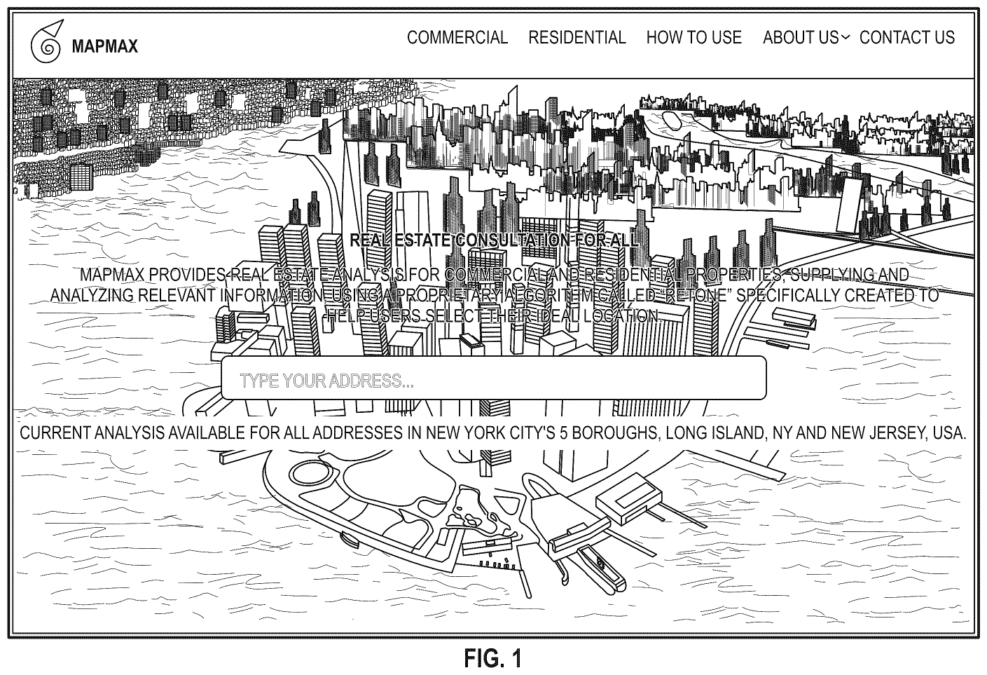

FIG. 1 is an example of a GUI for entering a physical address, in accordance with aspects of the present disclosure. The GUI may be displayed on any display screen, such as a smartphone screen, laptop screen, television screen, computer monitor screen, or any other display screen. The GUI may be presented by a web browser, by a mobile app, or by a computer application.

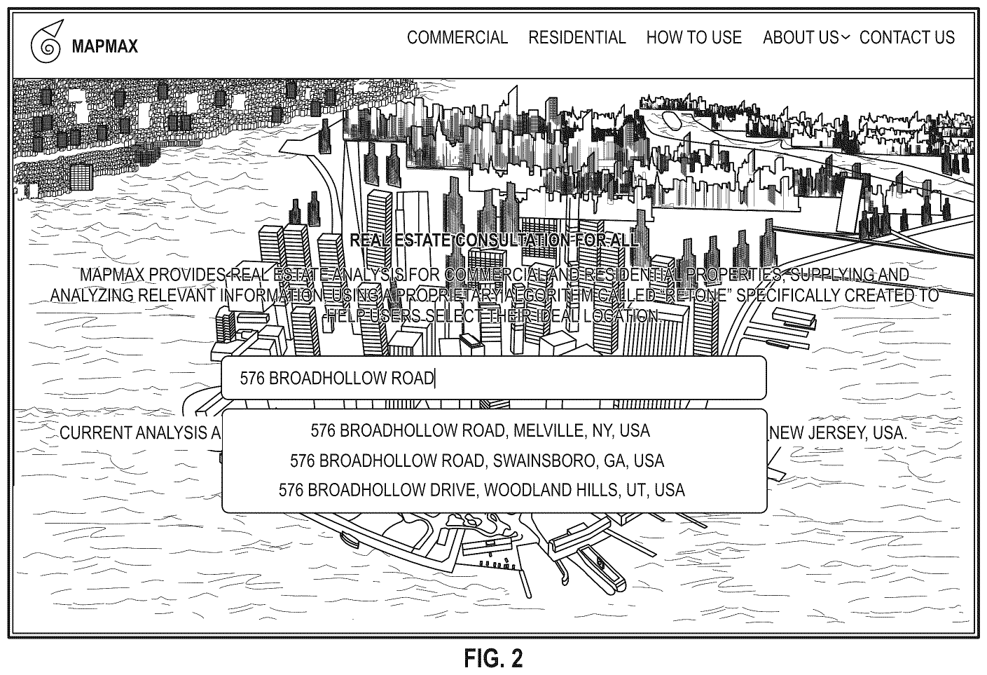

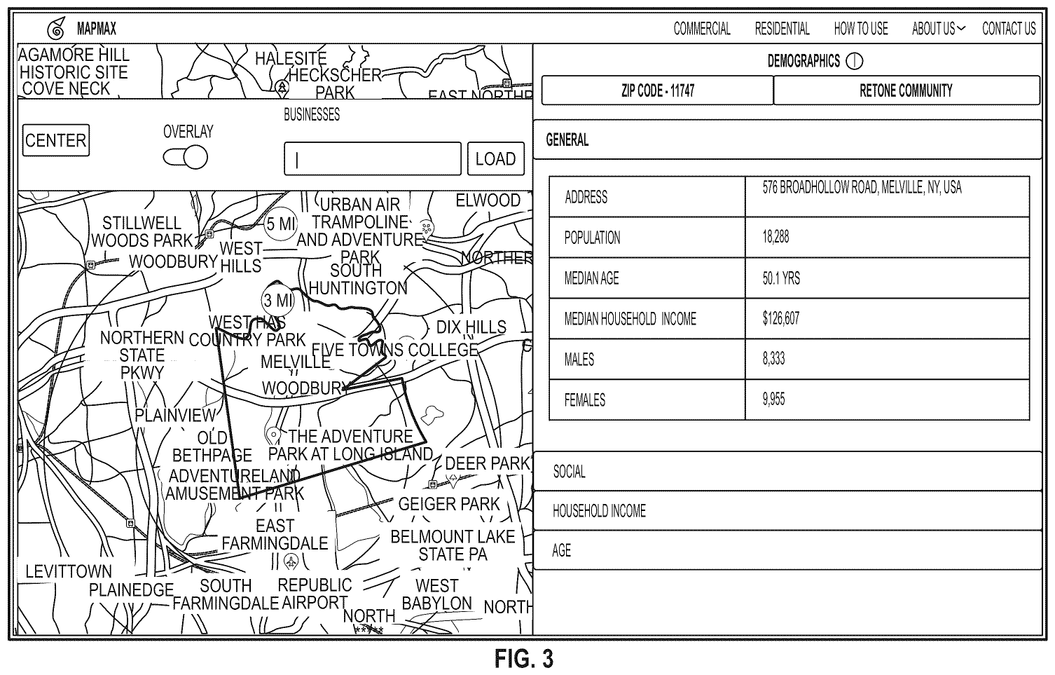

FIG. 2 is an example of the GUI of FIG. 1 showing an address suggestion feature, in accordance with aspects of the present disclosure. As the user types in an address or portion of an address into the search bar, the search bar generates a list of suggested addresses that match the user's entry. The suggested addresses may be determined and provided by a server that is in communication with the device displaying the GUI. Persons skilled in the art will understand how to implement suggested addresses. Upon entering a full address into the search bar or selecting a suggested address, the user may engage the “Go” button, which may be a button showing a magnifying glass or other icon, or the user may press an “enter” or “return” button on a physical or virtual keyboard. Then, the GUI will transition to the GUI of FIG. 3.

FIG. 3 is an example of another GUI showing various elements, including a map showing a physical location entered by a user, in accordance with aspects of the present disclosure. The GUI of FIG. 3 includes a map portion and an information portion. In the illustrated embodiment, the map portion is shown on a left side of the GUI and the information portion is shown on a right side of the GUI. The illustrated arrangement is merely an example, and other arrangements are contemplated to be within the scope of the present disclosure.

The map portion shows a map marker designating the address entered by the user and includes boundary indications that will be referred to herein as transit time or transit-distance boundary. As used herein, a “transit-time boundary” encompasses a region that requires at most a particular transit time to reach the address entered by the user, and a “transit-distance boundary” encompasses region that is at most a particular transit distance away from the address entered by the user. Two transit distance boundaries are illustrated in the example of FIG. 3—a three-mile transit-distance boundary and a five-mile transit-distance boundary.

In accordance with aspects of the present disclosure, a transit-time boundary for an address and a transit-distance boundary for an address may be determined using publicly available traffic data. In embodiments, a transit-time boundary or a transit-distance boundary may be determined for different time periods of a day (e.g., morning, afternoon, evening) for and/or different time periods of a week (e.g., weekday, Saturday, Sunday). In various embodiments, the transmit time boundary or transit-distance boundary may be determined by using publicly available traffic data to determine travel times and travel distances in a grid surrounding the address entered by the user. For example, the grid around the address entered by the user may be a circular grid, a square grid, other another grid shape. The travel time and travel distance from each grid location to the address entered by the user may be determined, and grid locations having the same travel time or travel distance may form a travel time boundary or a travel distance boundary. Other manners of determining a travel time boundary or a travel distance boundary are contemplated to be within the scope of the present disclosure.

In embodiments, the time threshold for a transit-time boundary is selectable and may be selected by the user (e.g., 5-minute travel time, 10-minute travel time, etc.). In embodiments, the distance threshold for a transit-distance boundary is selectable and may be selected by the user (e.g., 1 mile travel distance, 2 mile travel distance, etc.).

In various embodiments, more populated regions may utilize a smaller travel distance threshold, whereas less populated regions may utilize a larger travel distance threshold. As an example, the following regions may have the travel distance thresholds shown below:
Brooklyn travel distance threshold: 2 miles
Bronx travel distance threshold: 1 mile
Queens travel distance threshold: 2 miles
Staten Island travel distance threshold: 5 miles
Manhattan travel distance threshold: 1 mile
Nassau County, New York travel distance threshold: 5 miles
Suffolk County, New York travel distance threshold: 5 miles
New Jersey travel distance threshold: 5 miles

The examples are merely illustrative, and other travel distance thresholds and time distance thresholds are contemplated to be within the scope of the present disclosure.

In embodiments, the time period for evaluating a transit-time boundary and/or a transit-distance boundary may be selectable and may be selected by a user (e.g., morning hours, lunch hours, afternoon hours, dinner hours, evening hours, or a specific time period, such as 9 AM-3 PM, among other possibilities).

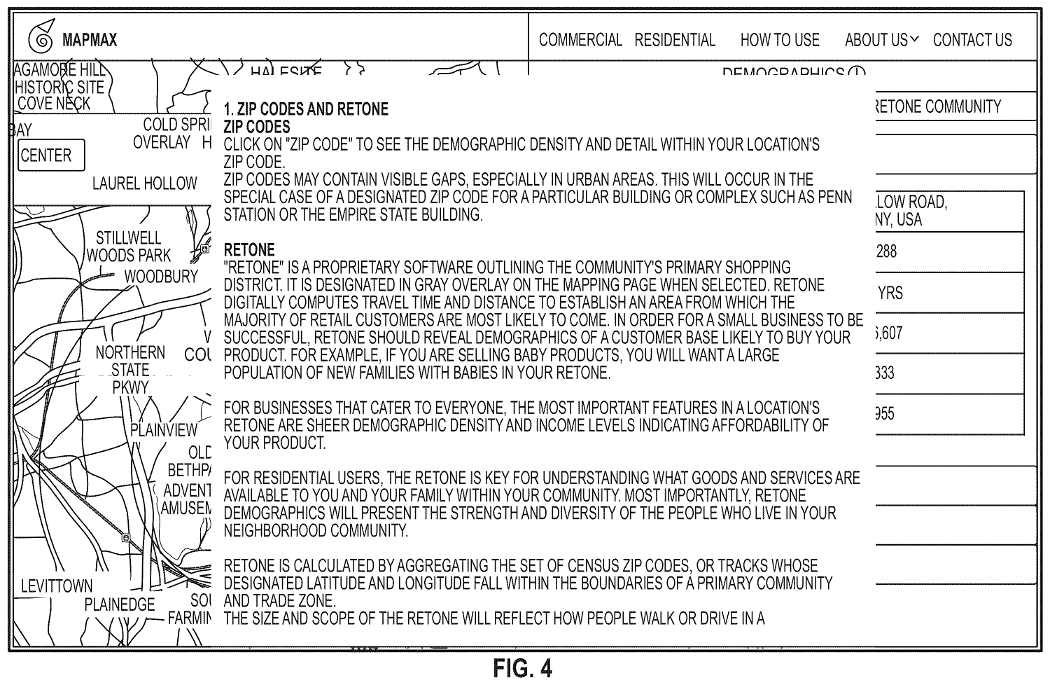

FIG. 4 is an example of a pop-up window or panel that describes a zip code mode and what is referred to herein as a “RETONE” mode for the data portion of the GUI of FIG. 3. In the zip code mode, the data portion of the GUI of FIG. 3 provides data about a particular zip code (e.g., the zip code where the physical address is located). In the RETONE mode, the data portion of the GUI of FIG. 3 provides data about a region encompassed by a time transit boundary or a time distance boundary, which will be referred to herein as a RETONE region or RETONE community.

Referring again to FIG. 3, in the zip code mode, the GUI of FIG. 3 displays general data about the zip code, including, for example, population in the zip code, median age in the zip code, median house hold income in the zip code, number of males in the zip code, and number of females in the zip code. The displayed data may be based on census data or from other data sources.

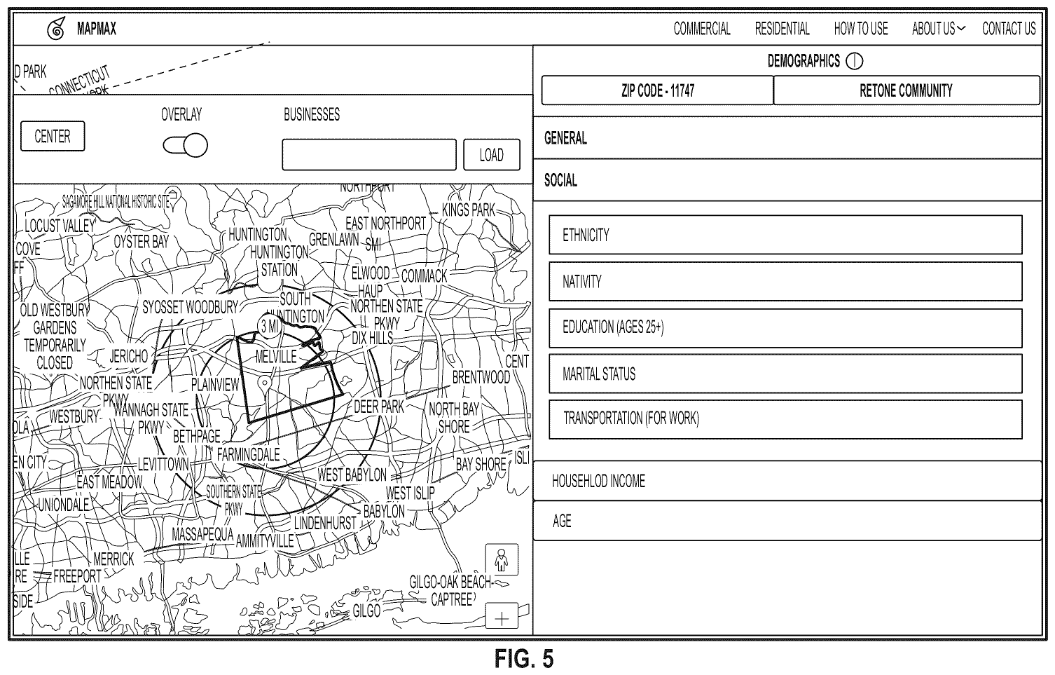

FIG. 5 is an example of selectable fields for showing social information for a zip code in the GUI of FIG. 3, in accordance with aspects of the present disclosure. The selectable fields may include ethnicity, nativity, education (e.g., for residents age 25 or higher), marital status, and mode of transportation (e.g., for work).

In various embodiments, the ethnicity selection may expand to show data such as number of or percentage of the population in the zip code of particular ethnicities, among other data.

In various embodiments, the nativity selection may expand to show data such as number of or percentage of the population in the zip code that are U.S. natives or foreign born, among other data.

In various embodiments, the education selection may expand to show data such as number of or percentage of the population in the zip code that have less than high school education, have high school degree, have some college or associates degree, have bachelors degree, and/or have graduate degree, among other data.

In various embodiments, the marital status selection may expand to show data such as number of or percentage of the population in the zip code that are married, that were never married, or that are divorced, among other data.

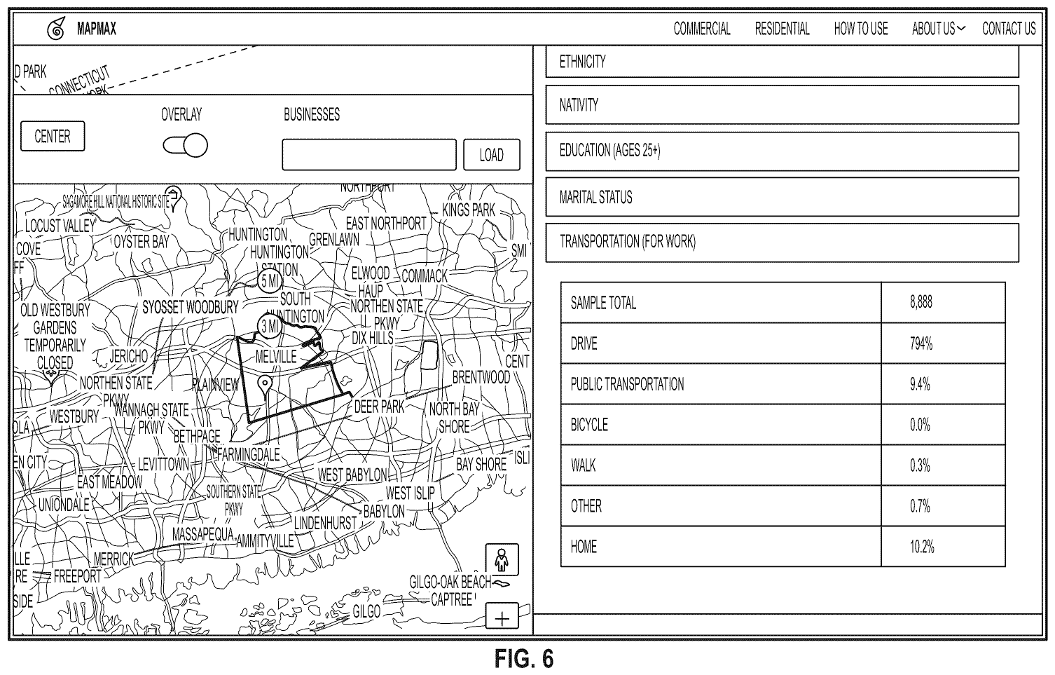

In various embodiments, the transportation (for work) selection may expand to show data such as number of or percentage of the population in the zip code that drive, take public transportation, bicycle, walk, and/or stay at home, among other data. An example of this data is shown in FIG. 6. FIG. 6 is an example of data showing transportation modes utilized in the zip code in the GUI of FIG. 3, in accordance with aspects of the present disclosure.

The social data describe in connection with FIG. 5 and FIG. 6 are merely examples, and other data are contemplated to be within the scope of the social data selection.

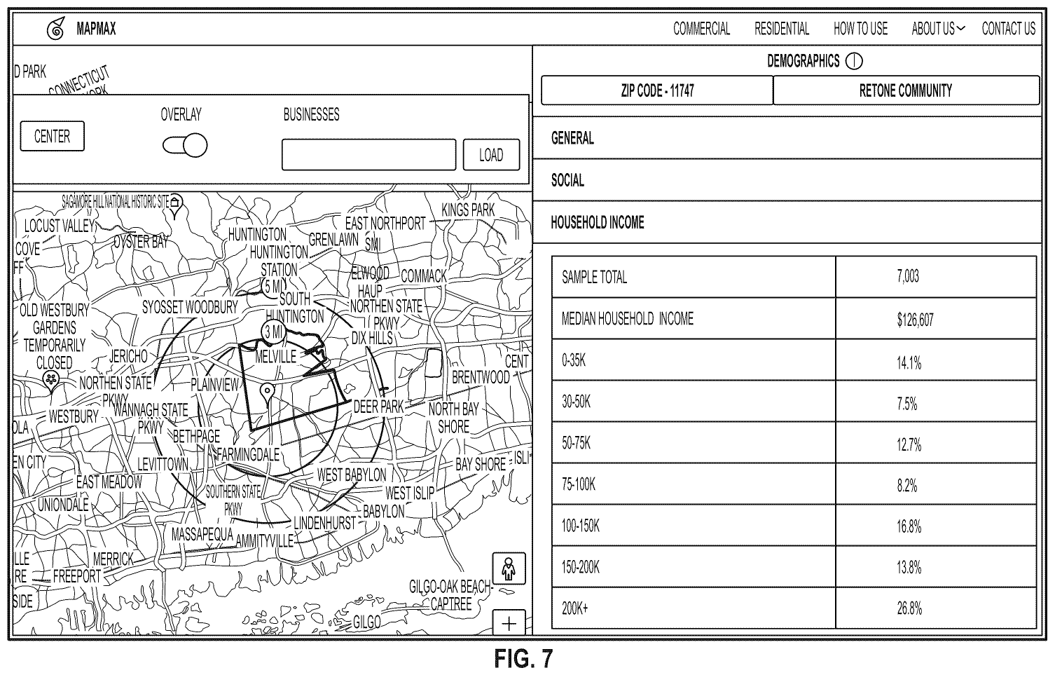

FIG. 7 is an example of data showing household income in U.S. dollars in the zip code in the GUI of FIG. 3, in accordance with aspects of the present disclosure. In the example of FIG. 7, the income brackets are labeled as 0-35 k, 35-50 k, 75-100 k, 100-150 k, 150-200 k, and 200 k+. Other income brackets may be used and are contemplated to be within the scope of the present disclosure. The data of FIG. 7 shows the number of or percentage of family income in the zip code in each bracket.

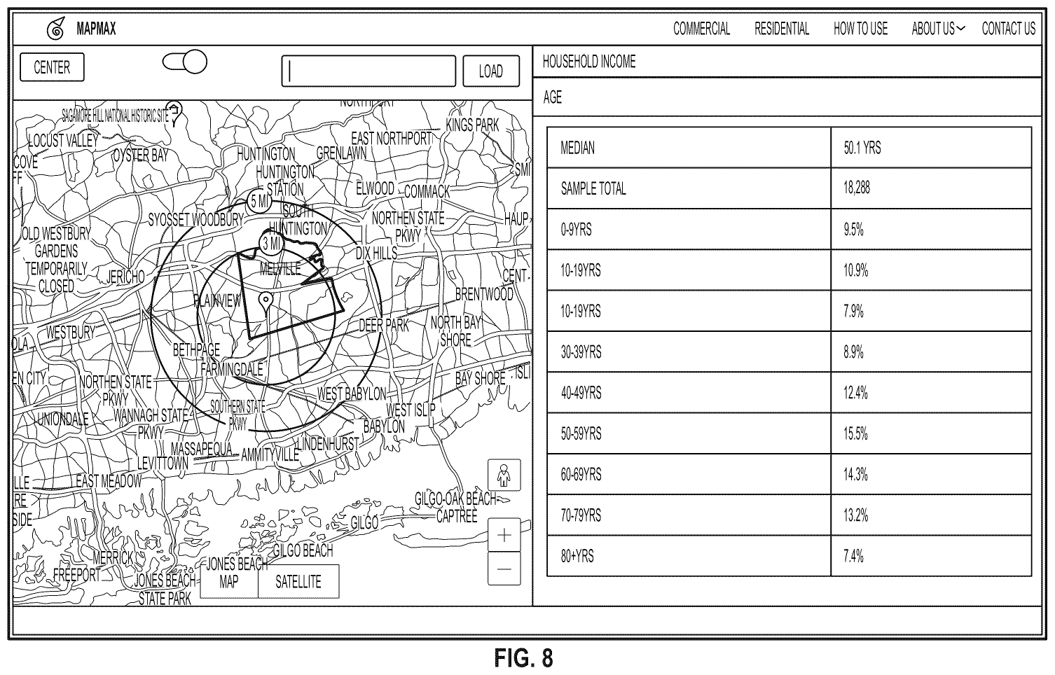

FIG. 8 is an example of data showing age distribution in the zip code in the GUI of FIG. 3. In the example of FIG. 8, the age brackets are every ten years, such as 0-9 years old, 10-19 years old, and so on. In embodiments, the last age bracket may be 80+ age bracket. Other age brackets may be used and are contemplated to be within the scope of the present disclosure. The data of FIG. 8 shows the number of or percentage of population in the zip code in each age bracket.

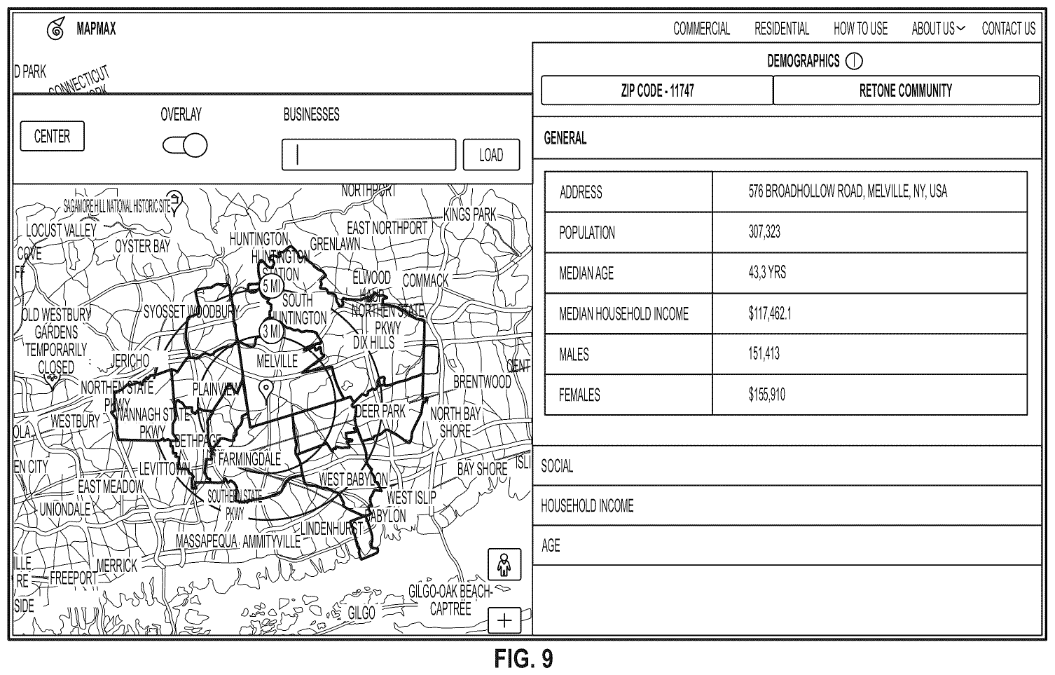

Data in the zip code mode were described above in connection with FIGS. 3 and 5-8. Data in the RETONE mode will be described below in connection with FIGS. 9-13. In the examples of FIGS. 9-13, the boundary of the RETONE region is a transit-distance boundary of five miles. In other embodiments, the boundary may include a transit-distance boundary and/or a transit-time boundary, and the threshold for the boundary may be fixed or may be adjustable by a user.

FIG. 9 is an example of a GUI for showing data in regions that are within one or more transit time or distance boundary of a physical address (called RETONE community), in accordance with aspects of the present disclosure. In the RETONE mode, the GUI of FIG. 9 displays general data about the RETONE region, including, for example, population in the RETONE region, median age in the RETONE region, median household income in the RETONE region, number of males in the RETONE region, and number of females in the RETONE region. The displayed data may be based on census data or from other data sources.

In various embodiments, the data in the RETONE region may be based on data for residents of any zip codes that are wholly or partially encompassed by the RETONE region. In various embodiments, the data in the RETONE region may be based on data for residents that reside within the RETONE region. A hybrid approach or another approach may be used to determine the data of FIG. 9.

In various embodiments, the data in the RETONE region may be based on census data for census blocks, census tracts, or zip code tabulation areas (ZCTAs).

Census Blocks: A census block is the smallest geographic unit used by the United States Census Bureau. Each block is bounded by visible features like roads, rivers, and city, county, or state boundaries. In urban areas, a block may correspond to a city block, but in rural areas, blocks can be large, irregularly shaped, and bounded by features such as streams or roads.

Census Tracts: A census tract is a relatively small, statistically consistent area that usually has a population size between 1,200 and 8,000 people, with most tracts housing around 4,000 people. Census tracts are designed to be relatively homogeneous units with respect to population characteristics, economic status, and living conditions.

ZIP Code Tabulation Areas (ZCTAs): ZCTAs are approximate area representations of U.S. Postal Service ZIP codes, created by the Census Bureau for the tabulation of census data. They are constructed by aggregating census blocks that share the same ZIP code reported by the majority of addresses in those blocks.

The census blocks, census tracts, and ZCTAs are already mapped and attached to Census data by a package called “CitySDK,” which can be used to access the census data. For example the “Manhattan” county area zip codes only use city block, other areas of New York City use census tracts, and New Jersey uses ZCTAs.

In accordance with aspects of the present disclosure, data for a RETONE region are gathered based on which census blocks, census tracts, or ZCTAs have “midpoint” longitude and latitude coordinates within the RETONE region. More specifically, each census block, census tract, or ZCTA data may include a specified longitude and latitude coordinate that designates a “midpoint” of the census block, census tract, or ZCTA. If such a midpoint is within a RETONE region, then all residents of such census block, census tract, or ZCTA may be considered to be within the RETONE community.

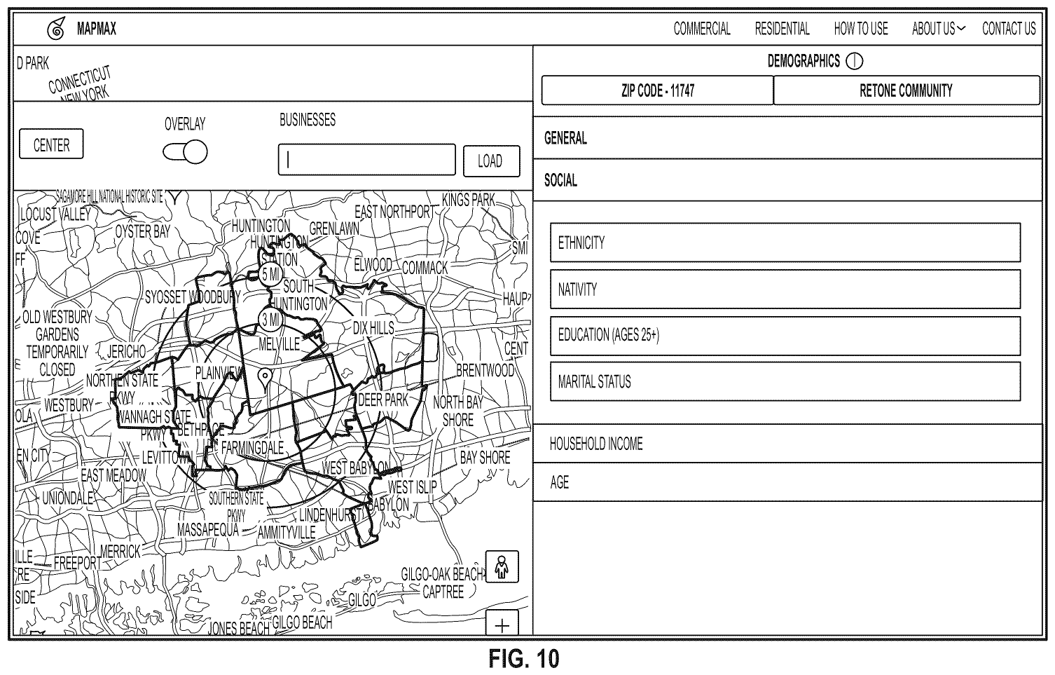

FIG. 10 is an example of selectable fields for showing social information for the RETONE region in the GUI of FIG. 9, in accordance with aspects of the present disclosure. FIG. 10 is an example of selectable fields for showing social information for a RETONE region in the GUI of FIG. 9, in accordance with aspects of the present disclosure. The selectable fields may include ethnicity, nativity, education (e.g., for residents age 25 or higher), and marital status.

In various embodiments, the ethnicity selection may expand to show data such as number of or percentage of the population in the RETONE region of particular ethnicities, among other data.

In various embodiments, the nativity selection may expand to show data such as number of or percentage of the population in the RETONE region that are U.S. natives or foreign born, among other data.

In various embodiments, the education selection may expand to show data such as number of or percentage of the population in the RETONE region that have less than high school education, have high school degree, have some college or associates degree, have bachelors degree, and/or have graduate degree, among other data.

In various embodiments, the marital status selection may expand to show data such as number of or percentage of the population in the RETONE region that are married, that were never married, or that are divorced, among other data.

The social data describe in connection with FIG. 10 are merely examples, and other data are contemplated to be within the scope of the social data selection. For example, the data for the RETONE region may include mode of transportation data, such as the type of data described and shown in connection with FIG. 6.

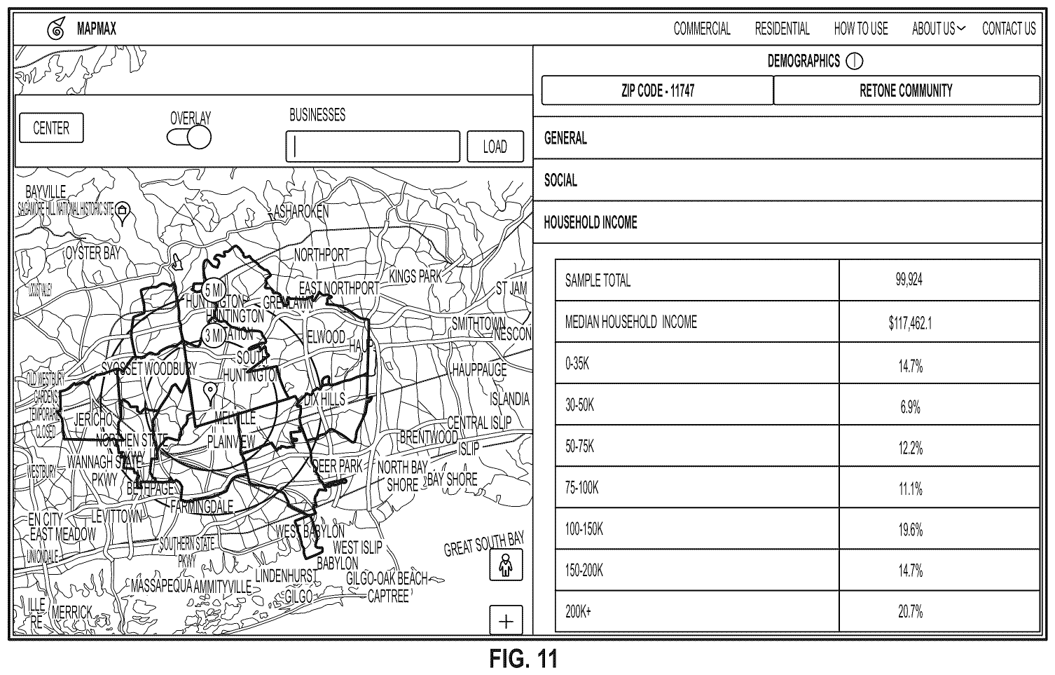

FIG. 11 is an example of data showing household income in the RETONE region in the GUI of FIG. 9, in accordance with aspects of the present disclosure. In the example of FIG. 11, the income brackets are labeled as 0-35 k, 35-50 k, 75-100 k, 100-150 k, 150-200 k, and 200 k+. Other income brackets may be used and are contemplated to be within the scope of the present disclosure. The data of FIG. 11 shows the number of or percentage of family income in the RETONE region in each bracket.

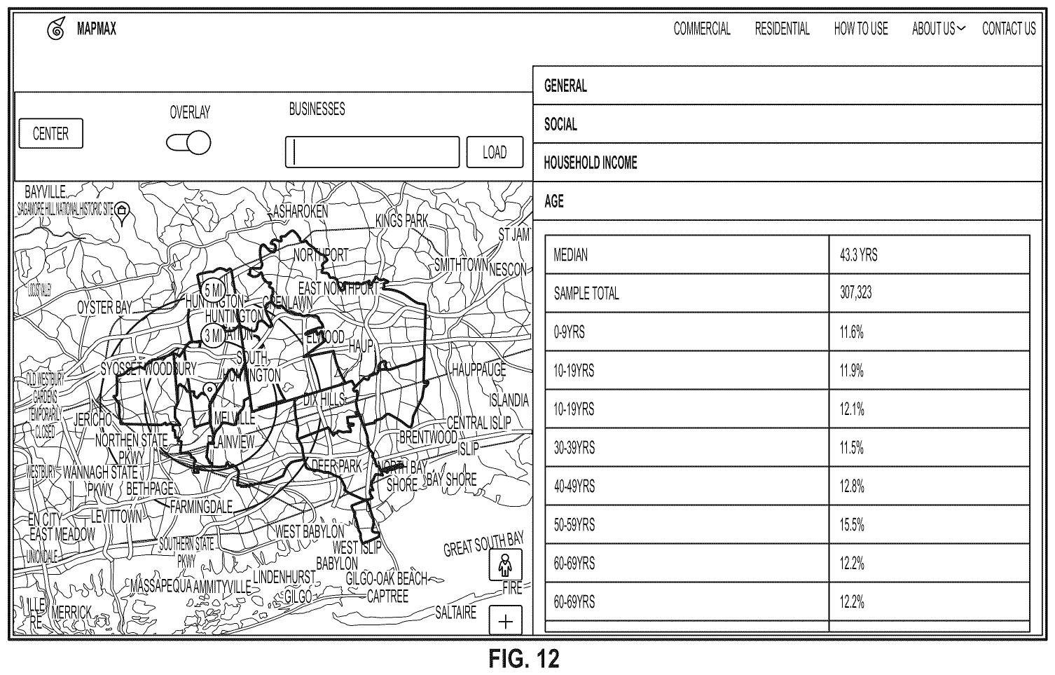

FIG. 12 is an example of data showing age distribution in the RETONE region in the GUI of FIG. 9. In the example of FIG. 12, the age brackets are every ten years, such as 0-9 years old, 10-19 years old, and so on. In embodiments, the last age bracket may be 80+ age bracket. Other age brackets may be used and are contemplated to be within the scope of the present disclosure. The data of FIG. 8 shows the number of or percentage of population in the RETONE region in each age bracket.

Accordingly, examples of data in the zip code mode were described above in connection with FIGS. 3 and 5-8, and examples of data in the RETONE mode were described above in connection with FIGS. 9-13.

A feature for searching for businesses or points of interest within a RETONE region will now be described.

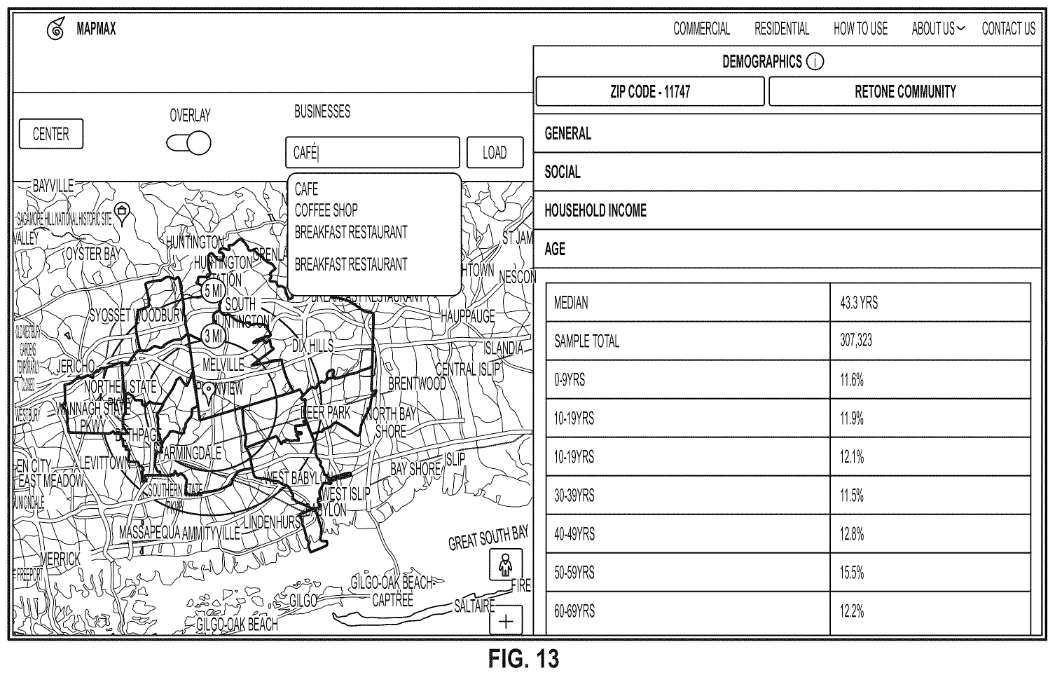

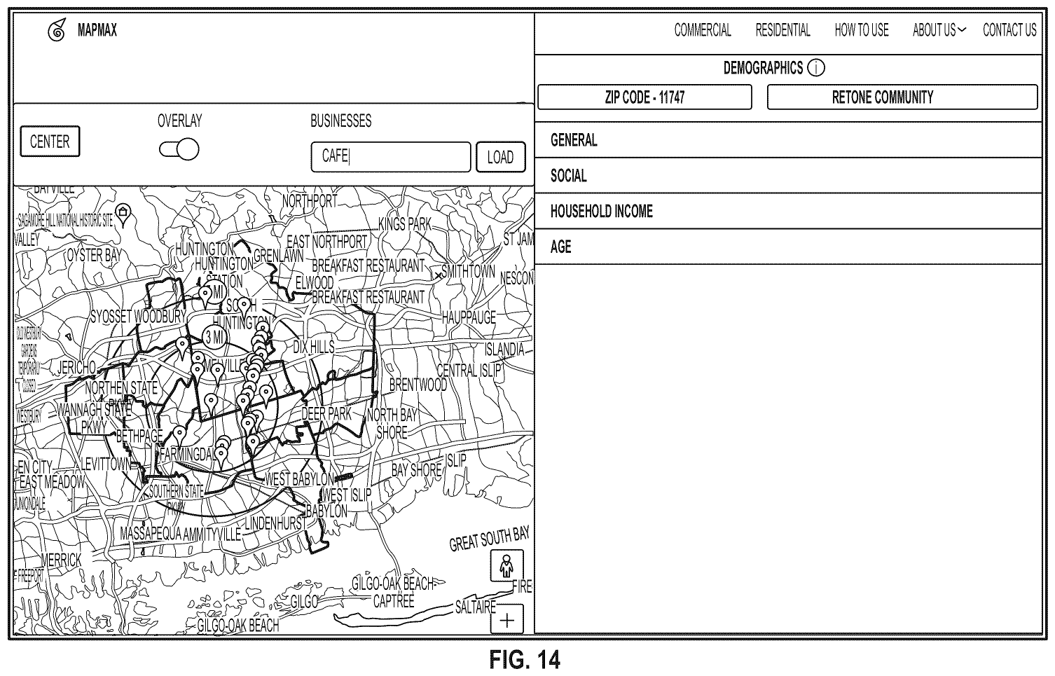

FIG. 13 is an example of using a search bar to search for businesses, destinations, or points of interest in the RETONE community in the GUI of FIG. 9, in accordance with aspects of the present disclosure. The search bar may provide suggested text as a user types, as shown in FIG. 13. In embodiments, any type of business, destination, or points of interest may be searched, including, without limitation, cafes, coffee shops, banks, grocery stores, clothing stores, post office locations, parks, bowling alleys, swimming pools, particular types of restaurants, laundromats, dry cleaners, museums, day care centers, schools, among other types of businesses or points of interest. Other types of businesses, destinations, or points of interest are contemplated to be within the scope of the present disclosure. A user may engage the “Load” button or press “enter” or “return” on a virtual or physical keyboard to perform the search, and the screen then transitions to the display of FIG. 14.

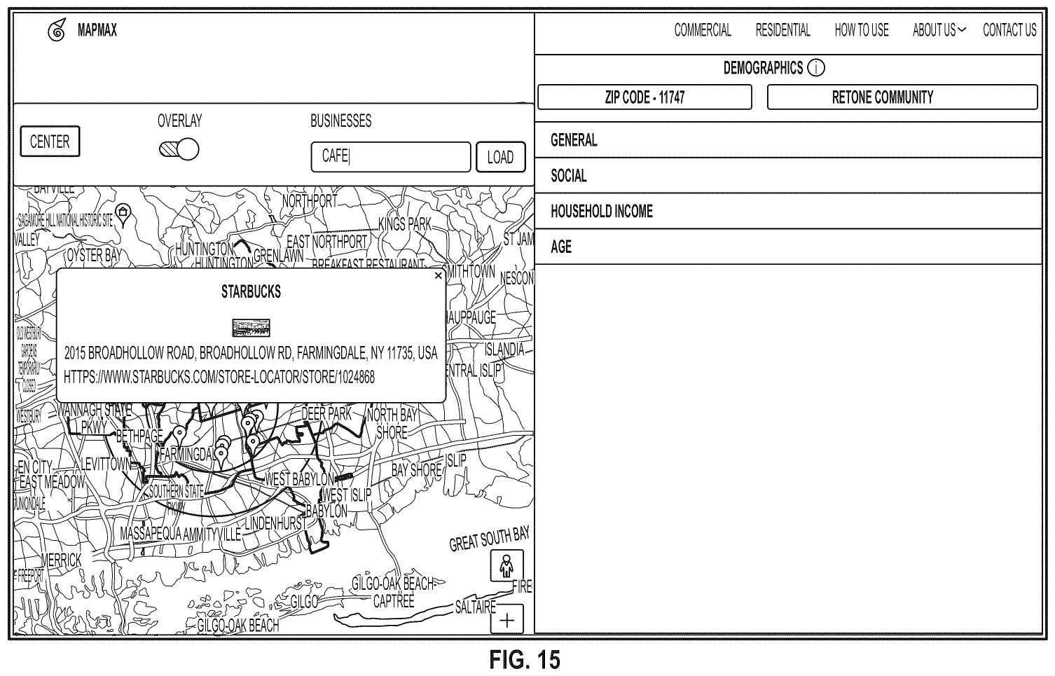

FIG. 14 is an example of map markers showing locations of cafes in the RETONE community in the GUI of FIG. 9, in accordance with aspects of the present disclosure. In various embodiments, the number of map markers may be limited to a configurable maximum number of results, such as twenty results or fifty results, for example. In the example of FIG. 14, all of the results and map markers are within the RETONE region. When a user engages a particular map marker, information for the map marker may be displayed, as shown in FIG. 15. FIG. 15 is an example of store information for a map marker selected by a user in the GUI of FIG. 9, in accordance with aspects of the present disclosure.

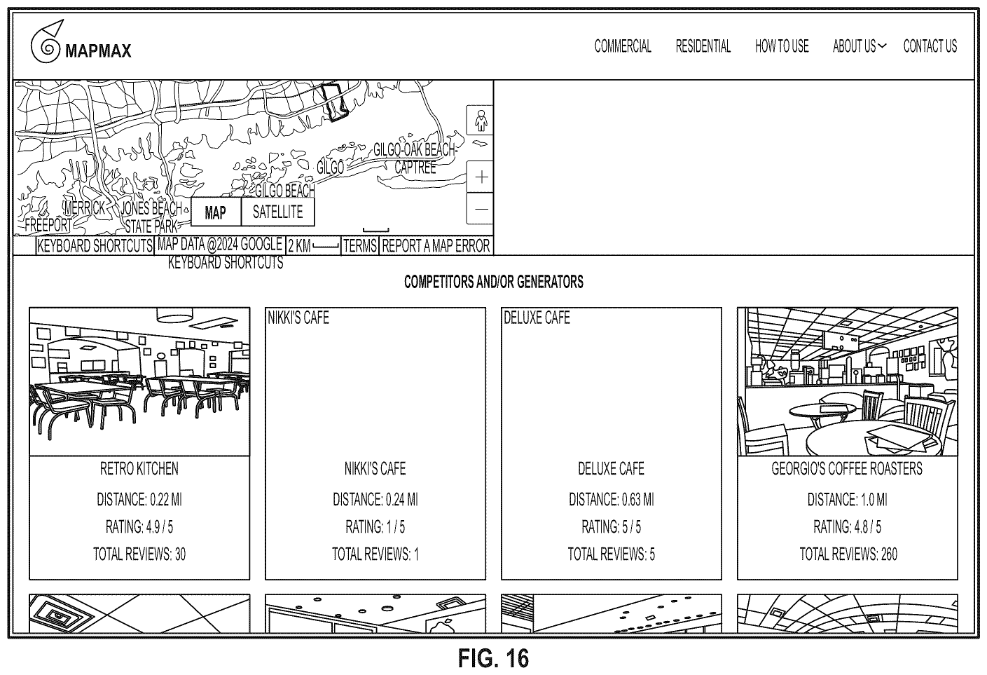

In various embodiments, information listings for the map markers may be displayed in a listing format, such as the format shown in FIG. 16. FIG. 16 is an example of information listings for the map markers in the GUI of FIG. 9, in accordance with aspects of the present disclosure. The information listing shown in FIG. 16 may be accessed in various ways, such as by scrolling the GUI of FIG. 9.

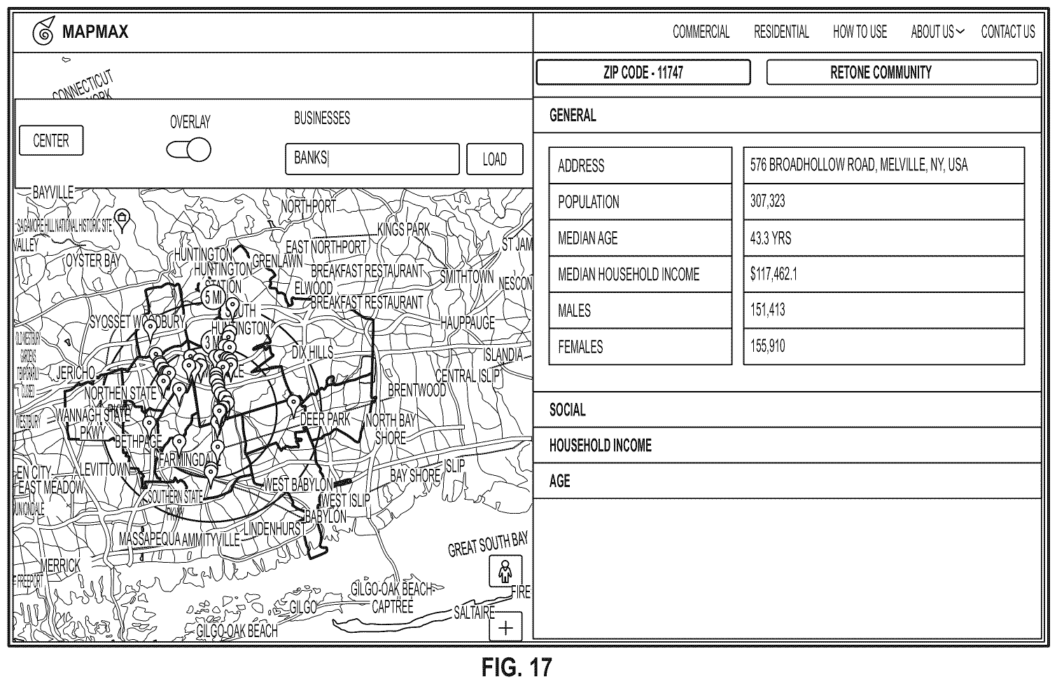

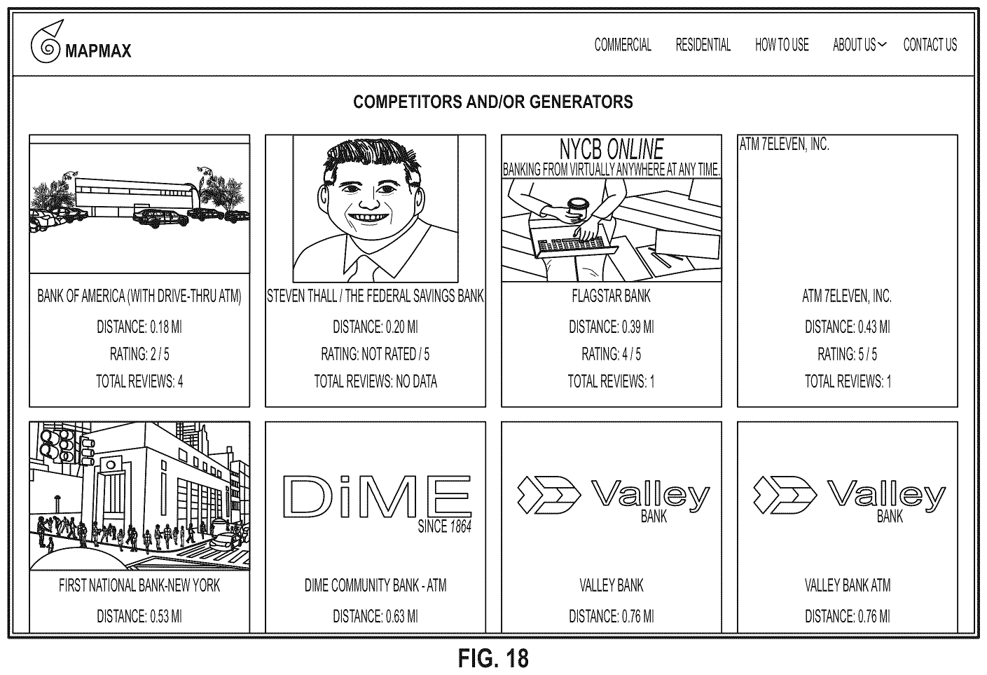

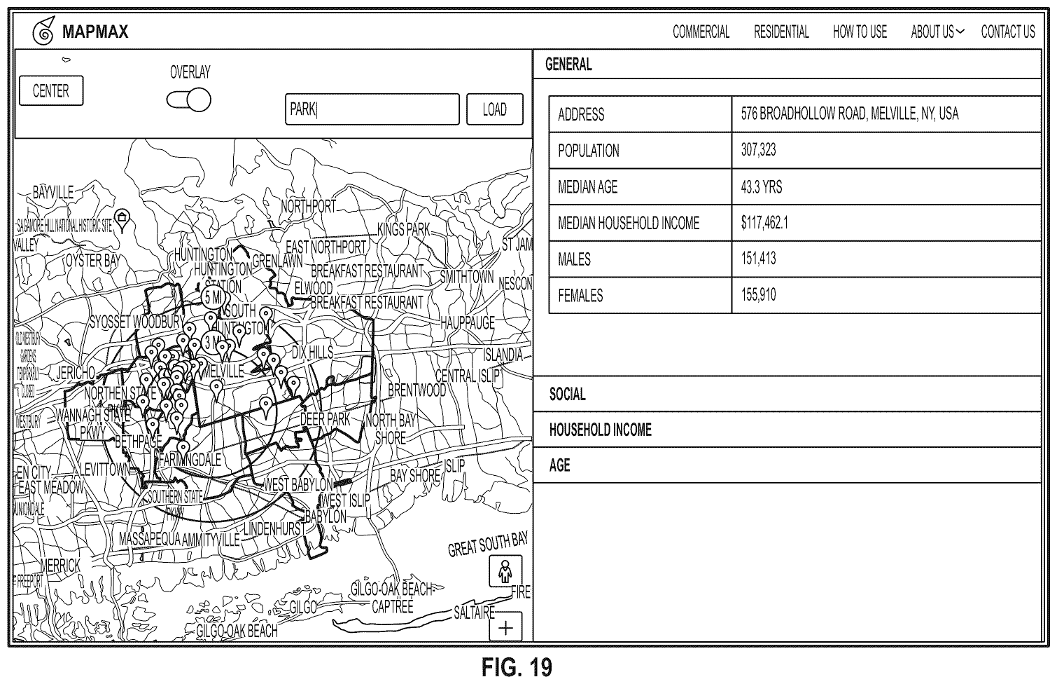

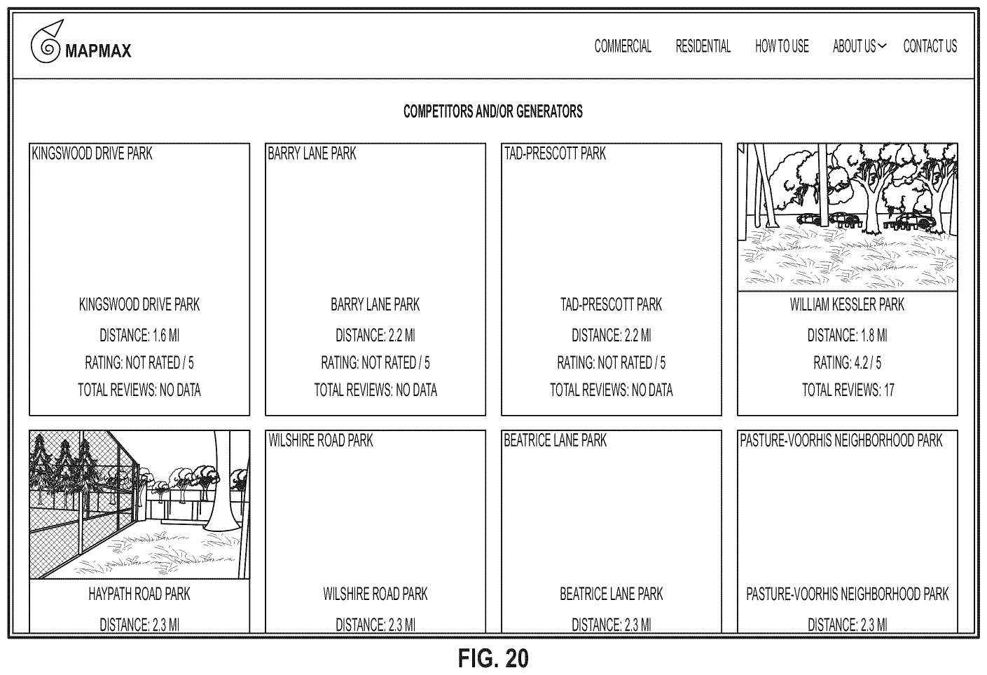

FIGS. 17-20 provide further examples of searches for different business or points of interest. FIG. 17 is an example of map markers for banks in the RETONE community in the GUI of FIG. 9, in accordance with aspects of the present disclosure. FIG. 18 is an example of information listings for the bank map markers displayed in the GUI of FIG. 17, in accordance with aspects of the present disclosure. FIG. 19 is an example of map markers for parks in the RETONE community in the GUI of FIG. 9, in accordance with aspects of the present disclosure. FIG. 20 is an example of information listings for the park map markers displayed in the GUI of FIG. 19, in accordance with aspects of the present disclosure.

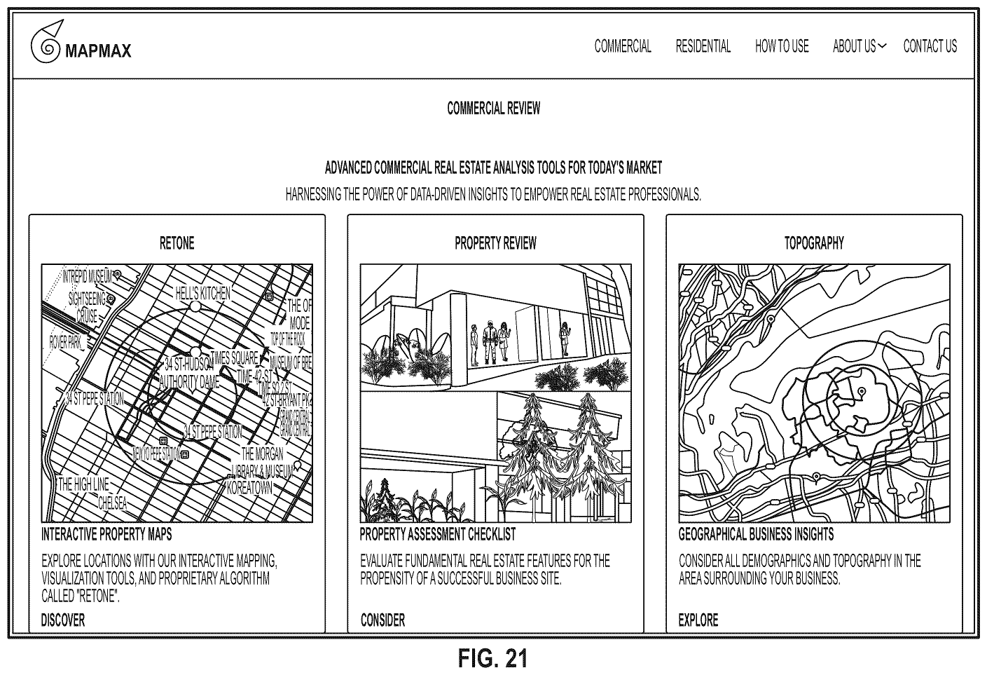

FIG. 21 is an example of a display screen for accessing various commercial review selections, in accordance with aspects of the present disclosure. The commercial review selections may include, for example, an interactive property map selection, a property assessment checklist selection, and a geographical business insight selection.

In various embodiments, the interactive property map selection provides RETONE analytics. When accessing a potential location's viability, a user should look at the RETONE demographics and study the maps and satellite images with the RETONE overlay. RETONE is represented by the shaded overlay that appears when selected on the map page. RETONE represents the community surrounding any typed in address. When accessing a potential location's viability, a user may look at the demographics, maps routes and satellite images within the RETONE overlay. This outlines a comprehensive look into the customer base encircling a real estate location. It takes into consideration the way potential customers travel, shop and “live” within their community. It also has a feature that lists existing business with pins within the RETONE. These establishments may generate business to a location or conversely compete for client revenue. It is beneficial and advantageous to study the RETONE of a proposed new location. In various embodiments, a property assessment checklist includes:
Good Visibility: the location should be easy to see and effortless for customers to find.
Bright and Big Signage: A prominent sign will show customers you are here and ready to do business.
Easy Accessibility: The location should be easy to get to/from roadways, streets and/or mass transit. For suburban drive live/work/shop areas, take into consideration lights by roadways, turns available into your location and curb cuts for easy access. For city pedestrian traffic, proximity to mass transit and major street/avenue intersections are an advantage
Strong Demographics: the “RETONE” feature outlines the community's primary shopping district. It is designated in gray overlay on the mapping page when selected. RETONE digitally computes travel time and distance to establish an area from which the majority of retail customers are most likely to come. In order for a small business to be successful, RETONE should reveal demographics of a customer base likely to buy your product. For example, if you are selling baby products, you will want a large population of new families with babies in your RETONE.
Study Generators: Generators are neighboring establishments and points of interest that are likely to generate customers into a store. For example, if opening a coffee shop in NYC, locating by a subway station with thousands of people passing by on their way to work-as indicated by high weekday morning turnstiles counts-will be an advantage for selling coffee. Additionally, the demographics of people who live and work in the RETONE have the highest potential to become customers throughout the day and weekend.
Evaluate Competitors: Businesses within a location's RETONE will compete for customer's dollars. In order for an operation to outperform other similar types of businesses in a shopping district, a location should have higher visibility, and be more easily accessible than the neighboring competition. The product should also be of better quality and sold at competitive price point. It pays to study the competition carefully.
Summary: In order for a location to be successful, it should have good visibility, big and bright signage, easy accessibility, and strong demographics that support a business concept. It is a big advantage to make a realistic review of generators-businesses who may bring customers to an establishment. Equally important is the evaluation of competitors-businesses who will complete for client revenue. With these tools and market intelligence, a business can be structured for maximum success.

In various embodiments, the platform provides a topography analysis. When accessing a location, it is advantageous to take note of the land's topography and natural barriers like rivers, lakes and parks. Customers may be reluctant to cross over or go around barriers to shop. It is advantageous to look over businesses and points of interest that can generate customers and also those that may compete to take customers away; analyze strengths and weaknesses within the RETONE, along with the location's individual merits of store layout, visibility and accessibility, and an educated analysis will help choose the best location with a much higher likeliness of success.

Entrepreneurial and franchise commercial business owners face challenges in financial planning, including the complexity of economic forecasting, the time-consuming nature of creating financial models based on real estate cost analysis, and the risk of human error.

In aspects of the present disclosure, the disclosed technology may include an “economic pro forma” feature for commercial businesses to use to streamline financial analysis, improve investment decision-making, and enhance the small business strategic planning process. The economic pro forma feature can automate financial calculations, integrate with real-time market data, customize templates for different types of commercial ventures, and present scenario analysis capabilities. This feature can present benefits such as time saving, increased accuracy, and informed decision-making based on real-time data. The economic pro forma features may be comprehensively supported by tutorial videos and guide graphic training.

The disclosed technology aims to transform how small business owners understand and interact with their potential customer base by providing real-time data tracking, advanced RETONE analytics, agency guidelines, and/or economic pro forma tools. By leveraging cutting-edge technology to track and analyze customer patterns, preferences, and movements, the disclosed technology enables entrepreneurs to make data-driven decisions that promote strategic planning and operational efficiency. This blend of features will help businesses navigate the complexities of site selection in the commercial real estate market and will also help to optimize operations of goods and services in their selected locations and to plan for future success with greater clarity.

The disclosed technology may deploy sophisticated algorithms and machine learning models to track and analyze vast amounts of data from cell phone towers and vehicle chips to illustrate the way people travel and shop from any given point in an area branching out into multiple directions. Such an approach would identify consumer behavior patterns and aid in predicting future spending habits based on historical data and emerging trends in real-time, thus providing businesses with insights to tailor their marketing strategies for their physical location.

By understanding potential customer spending habits and when consumers are most likely to pass by established locations, businesses can optimize their operations by adjusting store hours, modifying staffing levels, creating inventory management, and/or exercising promotions based on expected customer volumes.

In revealing patterns in aggregated data of potential consumers across different times of the year, seasons, days and even hours, businesses can plan and prepare for peak times, address off-peak challenges, and/or plan special events or promotions to attract more customers during slow periods.

The disclosed technology can incorporate a feature that allows consumers to provide feedback on their experiences of travel to a destination directly through the disclosed platform. There are many websites rating products, but none known specifically to review ease or difficulty of travel in and out of a given destination. This review process could offer valuable insights to complement the data collected, enabling businesses to better understand which physical features of commercial real estate best attract and serve their patrons.

The disclosed platform will operate to maintain ethical standards for the use of the data collected by the platform. The aim is to gain intuitive insights into consumer behavior as it pertains to commercial real estate, and support businesses in making informed decisions to enhance a competitive edge, yet to also prioritize individual privacy and strong ethics in the use of data. Because of the sensitivity of tracking consumer movements and spending habits, the disclosed technology will establish a privacy framework to ensure data is collected and processed in a manner that respects individual privacy and complies with all data protection regulations.

Privacy and security will always be of the utmost importance in the disclosed platform. In order to protect sensitive information and ensure the platform is secure and trustworthy, the disclosed platform will establish strong data protection policies and establish cybersecurity measures to safeguard user data and maintain compliance with all data protection laws and regulations.

Accordingly, the disclosed platform provides vital real estate information and also fosters a community of informed buyers, supported by the technology and expert insights.

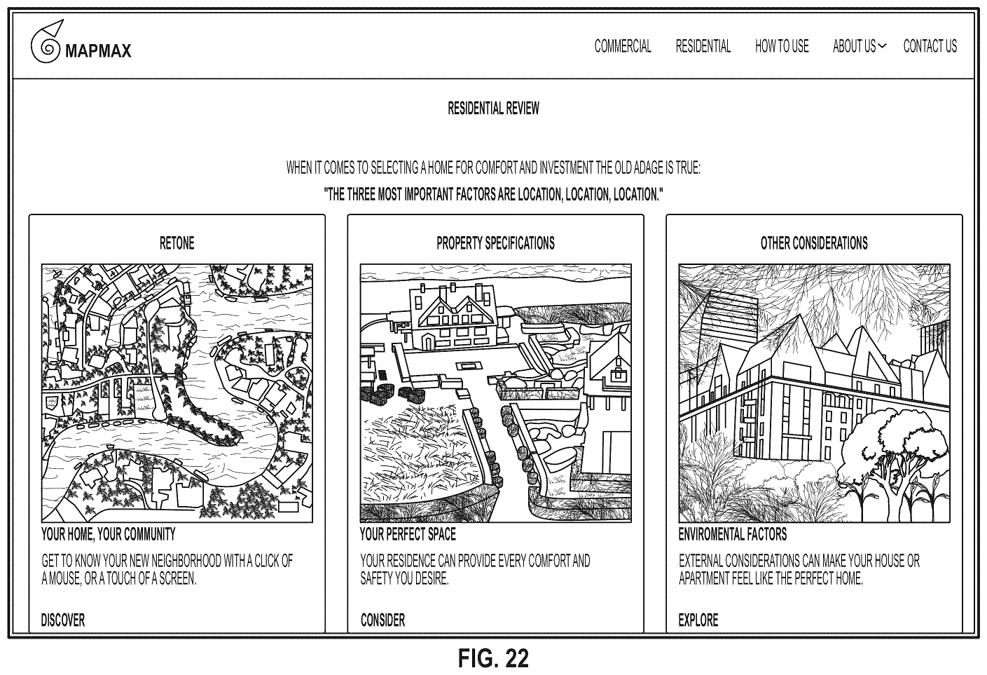

FIG. 22 is an example of a display screen for accessing various residential review selections, in accordance with aspects of the present disclosure. The residential review selections may include, for example, a RETONE selection, a property specifications selection, and a “other considerations” selection.

In various embodiments, a RETONE selection provides geographical information about potential new home locations to individuals and families. The RETONE features illustrates neighborhood demographics, services, and transportation. RETONE exhibits close-by needed resources like doctors, dentists, and veterinarians, as well as retail establishments like supermarkets, pharmacies, and restaurants. There are also points of interest available for viewing like schools, places of worship, and recreational facilities such as parks and gyms. RETONE recognizes a demographic community comprised of the diversity and shared aspirations of its people. RETONE demographics can help a family with young children find a community where there are other young children in the neighborhood for their kids to befriend. It can help a young professional person discover a neighborhood where other single young professionals live. Studying the RETONE overlay helps a user to better understand the diversity and strength of a community and to fully avail all a new home has to offer.

In various embodiments, a property specifications page allows users to view property information, such as: Address of Property, Asking Price for Sale or Rental, Type of Residential Property, Year Built/Age of Property, New Construction, Tax History, Common Area Charges/Maintenance Fees, and Days on the Market, and/or Date Available for Procession/Move In, and view property specifications such as: Total Square Footage, Date of Renovation, Specifications of Interior Space, Kitchen Features, Basement Details, Garage, Exterior and Additional Features, Pool, Fenced in Area, Deck, Patio, or Porch, and/or Seller or Broker Contact Information.

In various embodiments, an “other considerations” page may provide points for a user to consider, such as: how much space do you need? What can you afford to pay for rent or a monthly mortgage and down payment? Are you more comfortable in a quiet town or an action-packed city? How close to family and friends do you want to be? Would you like to live by the water and/or green spaces? What kind of view would you like? What near-by activities and events are available? Do you have a pet and need to be near a veterinarian, dog park, groomer, and pet sitting facility? Is it important to you to live in an area where most people share your political ideologies?

Various features have been described above. Other features will now be described.

In aspects, the disclosed platform includes features that will make pertinent public records, such as tax maps and zoning information, available to users. These types of public records are typically arduous to research. In aspects, the disclosed platform includes a centralized database that integrates tax maps, zoning maps, flood zone information, and/or other real estate data from multiple authoritative sources.

In aspects, the disclosed technology provides an intuitive and easy-to-navigate platform that allows users to find and visualize the information they need about a specific piece of land or property. Such data may be obtained from local and Federal government agencies, GIS (Geographic Information Systems) data providers, and real estate databases, to gather the most current and comprehensive information available. Educational resources and guides may be provided to educate potential buyers on factors directly influencing property purchase decisions.

Using a clean design and interactive map interface, users may layer different types of information (e.g., tax maps, zoning, flood zones) over a base map. Search and filter functions allows users to find properties or avoid properties based on specific criteria. Platform features, such as property value estimations, risk assessments for flooding or zoning restrictions, and property comparison tools, allows users to evaluate multiple properties simultaneously based on their budget and needs.

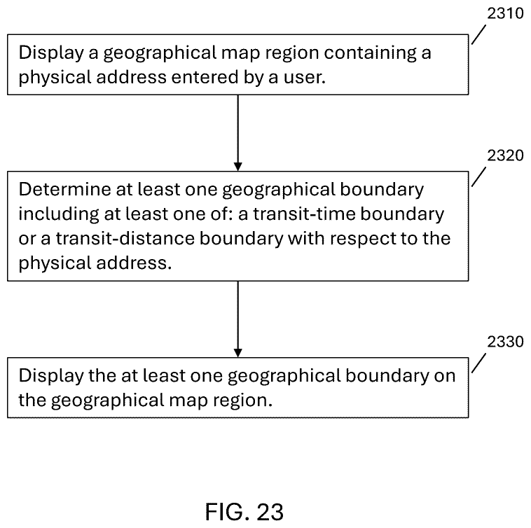

FIG. 23 shows an example of an operation for determining at least one travel-time boundary and/or travel-distance boundary.

At block 2310, the operation involves displaying a geographical map region containing a physical address entered by a user.

At block 2320, the operation involves determining at least one geographical boundary including at least one of: a transit-time boundary or a transit-distance boundary with respect to the physical address. The transit-time boundary and/or the transit-distance boundary may be determined in the manner described above herein or in another manner. For example, travel time and/or travel distance may be determined based on public data for each location in a grid surrounding the physical location, and the travel-time boundary and/or travel-distance boundary may be formed by locations in the grid which have travel times or travel distances satisfying a target travel time or target travel distance. The target travel time and/or target travel distance may be configurable by a user. For example, the target travel time may be configured by a user to be 10 minutes, or 15 minutes, or another target travel time. The target travel distance may be configured by a user to be 1 mile, or 3 miles, or 5 miles, or another target travel distance.

At block 2330, the operation involves displaying the at least one geographical boundary on the geographical map region.

FIG. 23 is merely an example, and variations are contemplated to be within the scope of the present disclosure.

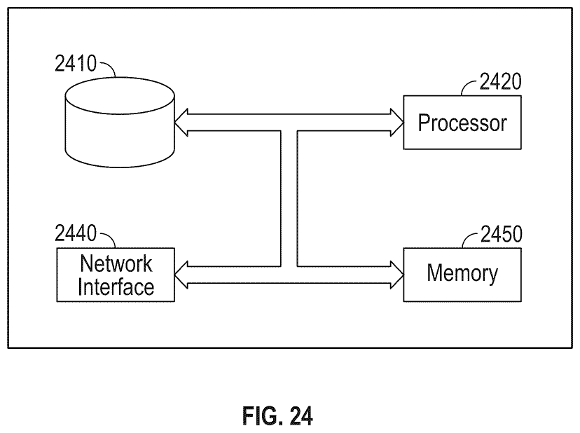

Referring now to FIG. 24, there is shown a block diagram of example components of an apparatus or platform that provides the disclosed technology (e.g., a server). The apparatus includes an electronic storage 2410, a processor 2420, a network interface 2440, and a memory 2450. The various components may be communicatively coupled with each other. The processor 2420 may be and may include any type of processor, such as a single-core central processing unit (CPU), a multi-core CPU, a microprocessor, a digital signal processor (DSP), a System-on-Chip (SoC), or any other type of processor. The memory 2450 may be a volatile type of memory, e.g., RAM, or a non-volatile type of memory, e.g., NAND flash memory. The memory 24350 includes processor-readable instructions that are executable by the processor 2420 to cause the apparatus to perform various operations, including those mentioned herein, such as the operations described above herein.

The electronic storage 2410 may be and include any type of electronic storage used for storing data, such as hard disk drive, solid state drive, optical disc, and/or other non-transitory computer-readable mediums, among other types of electronic storage. The electronic storage 2410 stores processor-readable instructions for causing or configured for causing the apparatus to perform its operations and also stores data associated with such operations, such as storing data relating to the description above, among other data. The network interface 2440 may implement wireless networking technologies such as 5G NR and/or other wireless networking technologies, and/or may implement wired networking technologies, such as Ethernet and/or other wired networking technologies.

The components shown in FIG. 24 are merely examples, and persons skilled in the art will understand that an apparatus includes other components not illustrated and may include multiples of any of the illustrated components. Such and other embodiments are contemplated to be within the scope of the present disclosure. For example, a transmitter and a receiver may be included as components for transmitting and receiving signals.

The embodiments disclosed herein are examples of the disclosure and may be embodied in various forms. For instance, although certain embodiments herein are described as separate embodiments, each of the embodiments herein may be combined with one or more of the other embodiments herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

The systems, devices, and/or servers described herein may utilize one or more processors to receive various information and transform the received information to generate an output. The processors may include any type of computing device, computational circuit, or any type of controller or processing circuit capable of executing a series of instructions that are stored in a memory. The processor may include multiple processors and/or multicore central processing units (CPUs) and may include any type of device, such as a microprocessor, graphics processing unit (GPU), digital signal processor, microcontroller, programmable logic device (PLD), field programmable gate array (FPGA), or the like. The processor may also include a memory to store data and/or instructions that, when executed by the one or more processors, causes the one or more processors to perform one or more methods and/or algorithms.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, Python, scripting languages, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

It should be understood that the foregoing description is only illustrative of the present disclosure. Various alternatives and modifications can be devised by those skilled in the art without departing from the disclosure. Accordingly, the present disclosure is intended to embrace all such alternatives, modifications and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed:

1. A system comprising:
at least one processor; and
one or more memory storing instructions which, when executed by the at least one processor, cause the system at least to perform:
displaying a geographical map region containing a physical address entered by a user;
determining at least one geographical boundary including at least one of: a transit-time boundary or a transit-distance boundary with respect to the physical address; and
displaying the at least one geographical boundary on the geographical map region.

2. The system of claim 1, wherein the determining the at least one geographical boundary comprises determining the transit-time boundary with respect to the physical address.

3. The system of claim 2, wherein the determining the transit-time boundary with respect to the physical address comprises:
determining travel times between the physical address and each location in a grid surrounding the physical address; and
determining the transit-time boundary based on the determined travel times in the grid which satisfy a target travel time,
wherein the target travel time is configurable by a user.

4. The system of claim 1, wherein the determining the at least one geographical boundary comprises determining the transit-distance boundary with respect to the physical address.

5. The system of claim 4, wherein the determining the transit-distance boundary with respect to the physical address comprises:
determining travel distances between the physical address and each location in a grid surrounding the physical address; and
determining the transit-distance boundary based on the determined travel distances in the grid which satisfy a target travel distance,
wherein the target travel distance is configurable by a user.

6. The system of claim 1, wherein the determining the at least one geographical boundary comprises determining at least one geographical boundary for at least one of: different time periods of a day, or different time period of a week.

7. A processor-implemented method comprising:
displaying a geographical map region containing a physical address entered by a user;
determining at least one geographical boundary including at least one of: a transit-time boundary or a transit-distance boundary with respect to the physical address; and
displaying the at least one geographical boundary on the geographical map region.

8. The processor-implemented method of claim 7, wherein the determining the at least one geographical boundary comprises determining the transit-time boundary with respect to the physical address.

9. The processor-implemented method of claim 8, wherein the determining the transit-time boundary with respect to the physical address comprises:
determining travel times between the physical address and each location in a grid surrounding the physical address; and
determining the transit-time boundary based on the determined travel times in the grid which satisfy a target travel time,
wherein the target travel time is configurable by a user.

10. The processor-implemented method of claim 7, wherein the determining the at least one geographical boundary comprises determining the transit-distance boundary with respect to the physical address.

11. The processor-implemented method of claim 10, wherein the determining the transit-distance boundary with respect to the physical address comprises:
determining travel distances between the physical address and each location in a grid surrounding the physical address; and
determining the transit-distance boundary based on the determined travel distances in the grid which satisfy a target travel distance,
wherein the target travel distance is configurable by a user.

12. The processor-implemented method of claim 7, wherein the determining the at least one geographical boundary comprises determining at least one geographical boundary for at least one of: different time periods of a day, or different time period of a week.

13. A processor-readable medium storing instructions which, when executed by at least one process or a system, cause the system at least to perform:
displaying a geographical map region containing a physical address entered by a user;
determining at least one geographical boundary including at least one of: a transit-time boundary or a transit-distance boundary with respect to the physical address; and
displaying the at least one geographical boundary on the geographical map region.

14. The processor-readable medium of claim 13, wherein the determining the at least one geographical boundary comprises determining the transit-time boundary with respect to the physical address.

15. The processor-readable medium of claim 14, wherein the determining the transit-time boundary with respect to the physical address comprises:
determining travel times between the physical address and each location in a grid surrounding the physical address; and
determining the transit-time boundary based on the determined travel times in the grid which satisfy a target travel time,
wherein the target travel time is configurable by a user.

16. The processor-readable medium of claim 13, wherein the determining the at least one geographical boundary comprises determining the transit-distance boundary with respect to the physical address.

17. The processor-readable medium of claim 16, wherein the determining the transit-distance boundary with respect to the physical address comprises:
determining travel distances between the physical address and each location in a grid surrounding the physical address; and
determining the transit-distance boundary based on the determined travel distances in the grid which satisfy a target travel distance,
wherein the target travel distance is configurable by a user.

18. The processor-readable medium of claim 13, wherein the determining the at least one geographical boundary comprises determining at least one geographical boundary for at least one of: different time periods of a day, or different time period of a week.
